(19) United States
(12) Patent Application Publication
(10) Pub. No.: US 2003/0219041 A1
(43) Pub. Date: Nov. 27, 2003

(54) Method for recording location information of broadcasting signals, and a broadcasting signal receiving device and transmitting device capable of recording location information of broadcasting signals

(75) Inventor: Seong-nam Oh, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS., LTD.

(21) Appl. No.: 10/430,350

(22) Filed: May 7, 2003

(30) Foreign Application Priority Data
May 27, 2002 (KR) 2002-29409

(51) Int. Cl. H04J 3/04

(52) U.S. Cl. 370/535

(57) ABSTRACT

Disclosed is a method for recording location information of broadcasting signals, and a broadcasting signal receiving device and transmitting device adapting the method. The method for recording location information of a broadcasting signal comprises the steps of extracting location information of an I-picture by removing header information of a Transport Stream, and synthesizing the extracted location information into a null packet of the Transport Stream. According to the present invention, it is possible to know the location information of the I-picture which records the entire picture in the broadcasting signals and accordingly reproduce only the I-picture of the corresponding location easily. In accordance with the broadcasting signal receiving apparatus, it is easy to perform the operations of fast forwarding, rewinding and trick modes.

### BACKGROUND OF THE INVENTION

1. Field of the Invention

The present invention relates to recording and reproducing broadcasting signals, and more particularly to a method for recording location information of broadcasting signals, and a broadcasting signal receiving device and a transmitting device capable of recording location information of broadcasting signals, wherein the location information of pictures among the broadcasting signals is stored in advance therein, and therefore it is possible to perform a high speed reproducing operation or to reproduce the pictures in a rewinding operation and a high speed forwarding operation, based on the stored information.

The present application is based on Korean Patent Application No. 2002-29409 filed on May 27, 2002, which is incorporated herein by reference.

2. Description of the Prior Art

An auxiliary memory of a computer system, that is, a hard disk drive has been used as a storage in a broadcasting signal receiving apparatus, where the hard disk drive can record a large amount of data and allow random access.

The broadcasting signal receiving apparatus including such storage receives a Transport Stream (TS), and records and reproduces the transport stream as a form of a broadcasting signal file in the storage.

However, when reproducing the recorded broadcasting signal file in the broadcasting signal receiving apparatus including the above storage, a user performs such operations as a fast forwarding and a rewinding to find a location that he/she wants to see. Additionally, when there is not enough time, the user may watch the recorded broadcasting in high speed after high-speed reproduction.

To do this, the conventional broadcasting signal receiving apparatus including the storage gathers indexes which represents where a plurality of Intra-pictures (hereinafter, referred to as I-pictures), which can reproduce still pictures of original pictures in themselves, are located in the image files of the broadcasting signal file, and stores the gathered indexes in the storage as an additional index file. When the user performs operations such as fast forwarding, rewinding and high-speed reproduction of the image files, the broadcasting signal receiving apparatus opens a corresponding index file and reproduces the I-picture at the location corresponding to the index.

FIG. 1 is a view illustrating a data structure in accordance with a conventional method for recording a location of a broadcasting signal file.

As shown in FIG. 1, in a MPEG file, an I-picture is followed by a plurality of B-pictures (Bidirectionally Predictive Pictures) and P-pictures (Predictive Pictures). Of these different pictures, the I-picture can be decoded irrespective of the neighboring frames.

Therefore, the above-discussed conventional method for recording the location of the broadcasting signal involves storing the index file which stores the location information of the I-picture, in a hard disk, separately.

FIG. 2 is a flowchart illustrating the process of the broadcasting signal receiving apparatus adopting the conventional method for recording the location of the broadcasting signal and performing operations such as fast forwarding and rewinding, to reproduce the broadcasting signals.

As shown in FIG. 2, the broadcasting receiving apparatus opens the index file (Step S202) stored in the storage and opens the MPEG file (Step S204).

Also, the location information of the I-picture is read based on the index information stored in the index file (Step S206), the I-picture corresponding to the location value in the MPEG file is extracted (Step S208), and the I-picture is decoded (Step S210). Therefore, the broadcasting receiving apparatus has to open both the index file and MPEG file, and, accordingly, it takes a lot of time to access the hard drive and things are very complicated.

### SUMMARY OF THE INVENTION

An object of the invention is to solve at least the above problems and/or disadvantages and to provide at least the advantages described hereinafter.

Accordingly, one object of the present invention is to solve the foregoing problems by providing a method for recording the location information of broadcasting signals, and a broadcasting signal receiving apparatus and transmitting apparatus capable of recording the location information of the broadcasting signal, wherein the location information of the intra picture is recorded, and whereby users can easily perform the operations of rewinding and fast forwarding, and can operate easily in trick modes, based on the location information.

Another object is to provide a method for inserting the information, which is extracted or operated from the broadcasting data received by the receiver, into a null packet of a Transport Stream.

Another object of the invention is to provide a method for recording the location information of broadcasting signals, comprising a step for removing header information from a Transport Stream and extracting the location information of the intra picture, and a step for synthesizing the extracted location information into the null packet of the Transport Stream.

Another object of the invention is to provide a broadcasting signal receiving apparatus equipped with a recording device which stores a received broadcasting signal file, wherein the apparatus comprises a location value generating unit for searching and extracting location information of an intra picture from a received transport stream, upon receiving the transport stream of a channel which a user wants to record, a storage for storing the location information in a recording medium after synthesizing the location information of the extracted intra picture into a null packet of the transport stream, and a control unit for reproducing an intra picture based on the location information of the recorded intra picture.

Preferably, the location information represents the intra pictures that are inserted, every predetermined number of frames, in the video stream whose header information is removed.

Preferably, the location information is an address of the intra picture of the Transport Stream stored in the recording device.

In the broadcasting signal receiving apparatus, the control unit reproduces the intra picture corresponding to the location information of the intra picture while performing the rewinding operation and the fast forwarding operation, when rewinding and fast forwarding commands are required.

The controller reproduces the intra picture of a corresponding location while skipping the location information of the intra picture by predetermined numbers.

The foregoing and other objects and advantages are realized by providing a broadcasting signal transmitting apparatus for recording location information therein, wherein the apparatus comprises a location information searching unit for searching the location information of an intra picture by checking that intra pictures are inserted, every predetermined number of frames, in a transport stream which a user wants to transmit, and a transmitting unit for transmitting a transport stream including the location information.

In addition, the location information searching unit forms a table of the location values obtained from the searched results to then make a form of TS packet.

### BRIEF DESCRIPTION OF THE DRAWINGS

The invention will be described in detail with reference to the following drawings in which like reference numerals refer to like elements wherein:

FIG. 1 is a view illustrating a data structure in accordance with a conventional method for recording location information of a broadcasting signal file;

FIG. 2 is a flowchart illustrating the process of a broadcasting signal receiving apparatus that adopts the conventional method for recording the location information of the broadcasting signals, and performs fast forwarding and rewinding operations and reproduces broadcasting signals;

FIG. 3 is a flowchart schematically illustrating the method for recording the location information of the broadcasting signals in accordance with the present invention;

FIGS. 4A to 4C show examples of the data structures in which location information values of the I-pictures are recorded in accordance with the method for recording the location information of the broadcasting signals of the present invention;

FIG. 4A shows an example of recording the location information of the I-picture in a null packet;

FIG. 4B and FIG. 4C show examples of recording the location information of the I-pictures in the front, back and particular locations of a TS (Transport Stream) file;

FIG. 5 is a block diagram of a broadcasting signal receiving apparatus adopting the method for recording the location information of the broadcasting signals in accordance with the present invention;

FIG. 6 is a flowchart schematically illustrating a reproducing process of a broadcasting signal receiving apparatus that adopts the method for recording the location information of the broadcasting signals in accordance with the present invention; and

FIG. 7 is a block diagram of a broadcasting signal transmitting apparatus adopting the method for recording the location information of the broadcasting signals in accordance with the present invention.

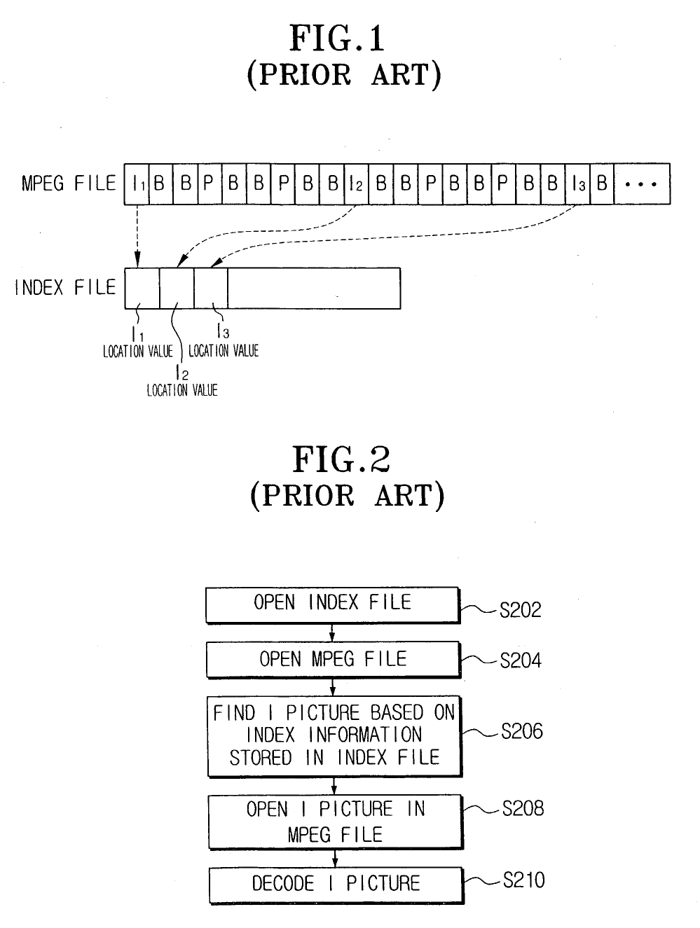

### DETAILED DESCRIPTION OF PREFERRED EMBODIMENTS

The following detailed description will present a method for recording location information of broadcasting signal and a broadcasting signal transmitting/receiving apparatus capable of recording the location information of broadcasting signal according to a preferred embodiment of the invention with reference to the accompanying drawings.

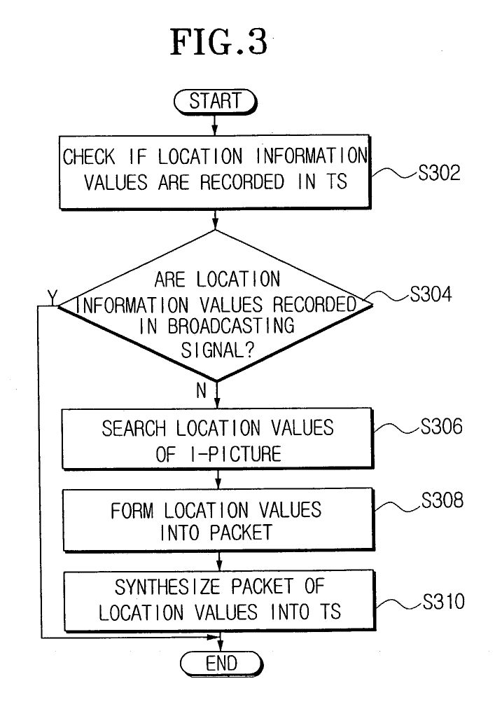

Hereinbelow, the method for recording location information of broadcasting signals in accordance with the present invention will be described with reference to FIG. 2 and FIG. 3.

FIG. 3 is a flowchart of the method for recording the location information of the broadcasting signals in accordance with the present invention.

First, it is checked whether the location information values are recorded in a transport stream (TS) (Step S302). At step S304, if the location information values are not recorded, a packet header is removed from the TS recorded in a broadcasting signal file and an elementary stream (ES) is formed.

The packet header includes such information as a video format, a color format, a coding method and an aspect ratio.

The location values of all the I-pictures are searched from a PES (Packetized Elementary Stream) (Step S306).

At this point, the location values, for example, are the values representing a particular numbered packet of the TS at which the first I-picture is located, and a numbered packet of the TS where the next I-picture is located, and so on.

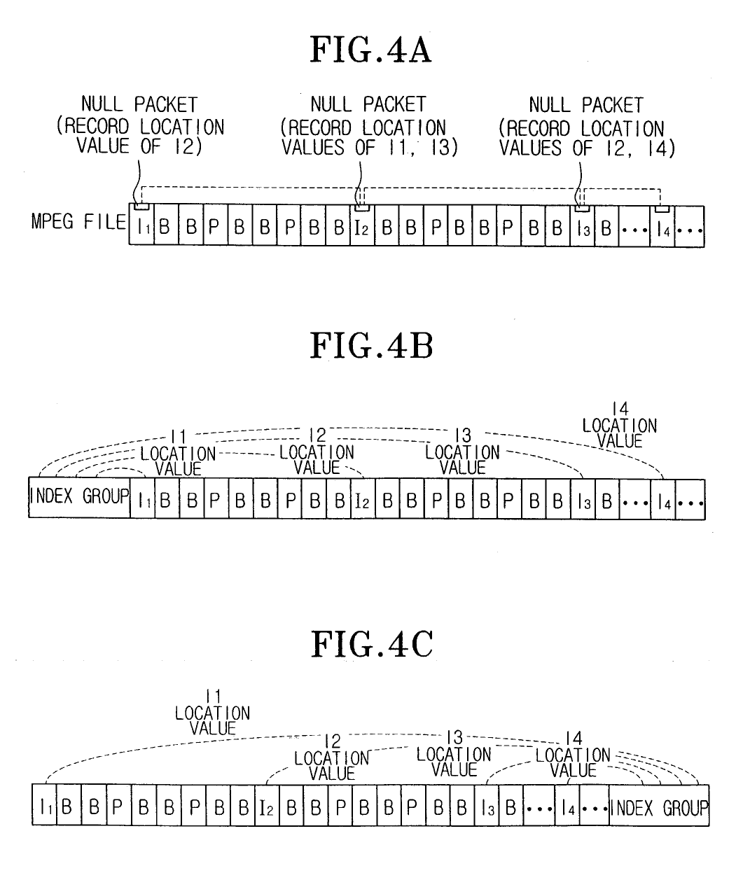

The location values obtained from the search results are made as a form of TS packet after being made into a table (Step S308). The TS packet, which stores the location values, is synthesized into a TS of the broadcasting signal file as shown in FIGS. 4A-4C (Step S310).

FIGS. 4A-4C show examples of data structures in which the location information values of the I-pictures are recorded in accordance with the method for recording the location information of the broadcasting signals of the present invention.

All data transmitted through a broadcasting channel are made into TS packets to transmit broadcasting signals as one stream. This TS includes a null packet, which doesn't have any information, for controlling frequency bandwidth.

FIG. 4A shows an example of recording location information of the I-picture in a null packet.

FIG. 4B and FIG. 4C show examples of recording the location information of the I-pictures in the front, back and in particular locations of the TS file. Also, the location information can, for example, be stored in index files of the TS.

When the TS in which the recorded location values are recorded, is recorded in the hard disk, it is possible to match the information representing the location values with a pointer indicating address information of the hard disk.

Now, the broadcasting signal receiving apparatus capable of recording the location information of the broadcasting signals in accordance with the present invention will be described.

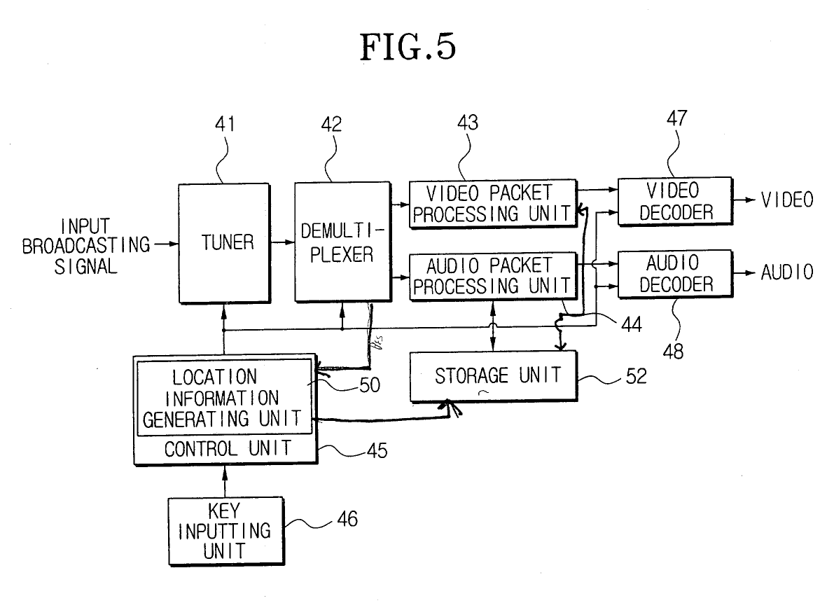

FIG. 5 is a block diagram of the broadcasting signal receiving apparatus capable of recording the location information of the broadcasting signals.

The broadcasting signal receiving apparatus includes a recording device (not shown) for storing the received broadcasting signal file.

The TS received from the channel tuned by a tuner 41 is inputted to a demultiplexer 42.

The demultiplexer 42 divides the inputted TSs into a video stream and an audio stream. A video packet processing unit 43 and an audio packet processing unit 44 perform a signal processing for receiving and outputting the divided video and audio streams, to output the processed results to a video decoder 47 and an audio decoder 48, respectively.

When among the broadcasting signals of the channel tuned by the tuner 41, the TS of the channel which a user wants to record is received, the demultiplexer 42 removes the header information on the video stream and gathers the video streams, whose header information is removed, to thereby form an ES stream, and then sends the ES stream to a location information generating unit 50. Here, the PES stream includes a B picture, a P picture and an I-picture.

The location information generating unit 50 searches the location values of the I-picture from the inputted PES stream. The location value of the I-picture is the location information representing that the I-pictures are inserted every predetermined number of frames.

The storage unit 52 synthesizes the received TS and the location values generated by the location information generating unit 50 to store as a broadcasting signal file in a recording medium.

At this time, the location values can be recorded at absolute locations such as the front or back locations of the file, or at the null packets of every frame.

When the broadcasting signal file into which the TS and the location values are synthesized, is stored in the recording medium, the location value of the I-picture in the broadcasting signal file corresponds to the address of the I-picture in the recording medium in which the broadcasting signal file is recorded.

On the other hand, when the broadcasting signal file is reproduced after being recorded, if the rewinding operation or the fast forwarding operation is selected through a key inputting unit 46, the control unit 45 performs the rewinding or fast forwarding operations, and simultaneously decodes and reproduces the corresponding I-picture based on the location information values of the I-picture in the broadcasting file stored in the recording medium.

Besides, the control unit 45, in a normal reproduction mode, decodes and reproduces the I-picture according to all location information values in the TS file, and in a trick reproduction mode, reads the location information values in the TS file while skipping by the numbers corresponding to its speed to then decodes and reproduces the I-picture of the corresponding location, in response to normal/trick reproduction mode signals inputted through the key inputting unit 46.

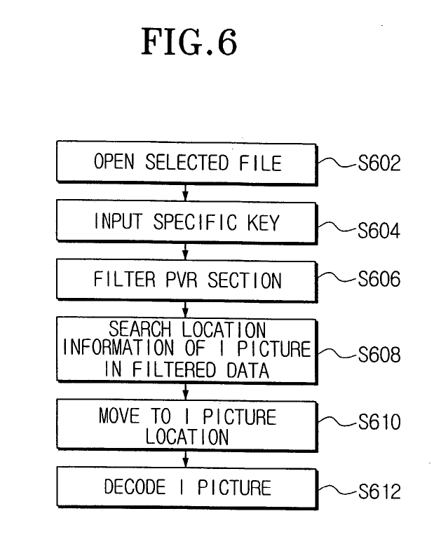

FIG. 6 is a flowchart schematically illustrating a reproducing process of the broadcasting signal receiving apparatus which is capable of recording the location information of the broadcasting signals in accordance with the present invention.

First, the broadcasting receiving apparatus opens a file selected by viewers (Step S602). If a specific key such as a fast forwarding/rewinding or a trick reproduction key is inputted to the corresponding file (Step S604), a PVR (Personal Video Recorder) section of the corresponding file is filtered (Step S606).

The broadcasting receiving apparatus searches the location information of the I-picture by extracting the section (Step S608). It moves to the location of the I-picture based on the searched location information (Step S610) and decodes the I-picture (Step S610).

Now, the broadcasting signal transmitting apparatus adopting the method for recording the location information of the broadcasting signal in accordance with the present invention will be described.

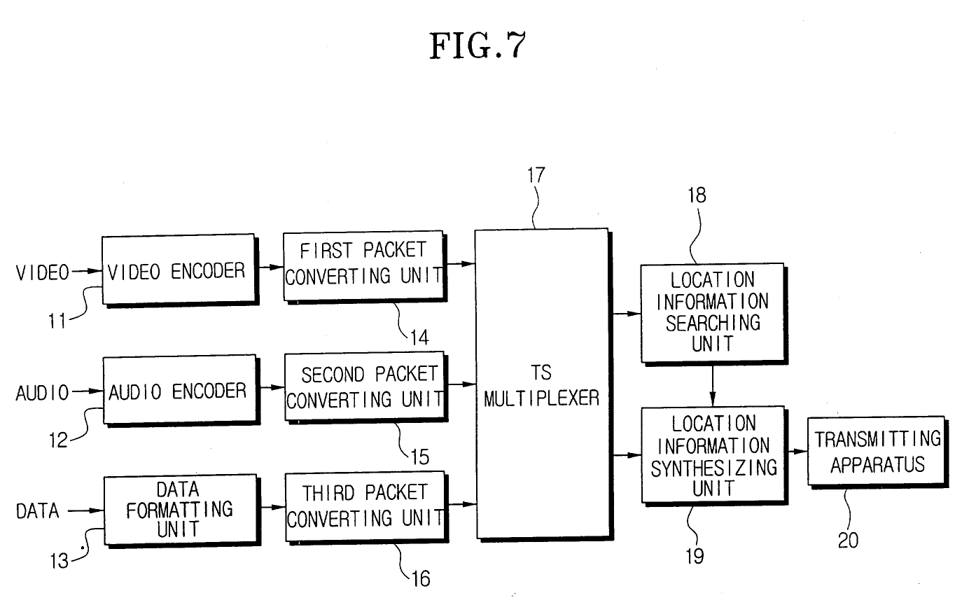

FIG. 7 is a block diagram of the broadcasting signal transmitting apparatus capable of recording the location information of the broadcasting signals in accordance with the present invention.

A video encoder 11 and an audio encoder 12 receive and compress video data, audio data, and other data, respectively, to generate a bit stream.

The first, second, and third packet converting units 14, 15, and 16 receive video, audio, and other data bit streams encoded respectively from the video encoder 11, the audio encoder 12, and the data formatting unit 13, for conversion into a packet of predetermined length.

Each packet generated through the first to third packet converting units 14, 15 and 16 is multiplexed in a TS multiplexer 17 to generate a Transport Stream.

The location information searching unit 18 searches the location values of the entire I-picture in the received Transport Stream, and forms the location values obtained from the searched results into a table to then make a form of a TS packet. The location information synthesizing unit 19 synthesizes a TS packet which has the Transport Stream generated in the TS multiplexer 17 and the location values obtained from the location information searching unit 18.

The TS whose location information is synthesized is transmitted through the transmitter 20.

As apparent from the above description, in accordance with the method for recording the location information of the broadcasting signal and the broadcasting signal transmitting/receiving apparatus capable of recording the location information of the broadcasting signal, it is possible to know the location information of the I-pictures which are used to record the entire picture in the broadcasting signals and accordingly reproduce only the I-pictures of the corresponding locations easily.

In accordance with the broadcasting signal receiving apparatus as described the above, it is easy to perform the operations of fast forwarding, rewinding and trick modes.

In accordance with the broadcasting signal transmitting apparatus as described the above, it is possible to transmit the TS which has the location information values.

While the invention has been shown and described with reference to certain preferred embodiments thereof, it will be understood by those skilled in the art that various changes in form and details may be made therein without deviating from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and is not intended to limit the scope of the claims. Many alternatives, modifications, and variations will be apparent to those skilled in the art. In the claims, means-plus-function clauses are intended to cover the structures described herein as performing the recited functions and do not only cover structural equivalents but also cover functionally equivalent structures.

What is claimed is:

1. A method for inserting information into a transport stream (TS), the method comprising the step of inserting one of information extracted from broadcasting data received by a receiver and information generated from the broadcasting data received by the receiver, into a predetermined area for the TS.

2. The method according to claim 1, wherein said predetermined area is a null packet of the TS.

3. The method according to claim 1, wherein said predetermined area is a front of a file of the TS.

4. The method according to claim 3, wherein the file of the TS is an index file.

5. The method according to claim 1, wherein said predetermined area is a back of a file of the TS.

6. The method according to claim 5, wherein the file of the TS is an index file.

7. A method for recording location information of a broadcasting signal, the method comprising:
receiving the broadcasting signal;
extracting location information of an I-picture by removing header information of a Transport Stream of the broadcasting signal; and
synthesizing the extracted location information into a predetermined area for the Transport Stream of the broadcasting signal, to form a synthesized Transport Stream; and
recording the synthesized Transport Stream onto a recording medium.

8. The method according to claim 7, wherein said predetermined area is a null packet of the Transport Stream.

9. A broadcasting signal receiving apparatus for recording a location information of a broadcasting signal, the apparatus equipped with a recording medium which stores a received broadcasting signal file, said broadcasting signal receiving apparatus comprising:
a location value generating unit for searching and extracting location information of an I-picture from a received Transport Stream (TS), when receiving the Transport Stream of a channel which a user wants to record;
a storage unit for synthesizing the extracted location information of said I-picture into a predetermined area for the Transport Stream, thereby to generate a synthesized TS for recording in the recording medium; and
a control unit for reproducing said I-picture from the recorded synthesized Transport Stream based on the location information.

10. The broadcasting signal receiving apparatus according to claim 9, wherein said predetermined area is a null packet of the Transport Stream.

11. The broadcasting signal receiving apparatus according to claim 9, wherein the I-picture is one of a plurality of I-pictures, and wherein the location information represents that a respective one of said plurality of I-pictures is inserted, every certain number of frames, in a video stream whose header information is removed.

12. The broadcasting signal receiving apparatus according to claim 9, wherein the location information is an address of the I-picture of the synthesized Transport Stream stored in the recording medium.

13. The broadcasting signal receiving apparatus according to claim 9, wherein the control unit reproduces the I-picture corresponding to the location information, while performing rewinding and fast forwarding operations, if rewinding and fast forwarding commands are required.

14. The broadcasting signal receiving apparatus according to claim 9, wherein the I-picture is one of a plurality of I-pictures, and wherein the control unit reproduces the I-picture at a corresponding location, while skipping through location information of said plurality of I-pictures every certain number of frames, if a trick mode is required.

15. A broadcasting signal transmitting apparatus, the broadcasting signal including location information recorded therein, the apparatus comprising:
a location information searching unit for searching for the location information of one of a plurality of I-pictures by checking that a respective one of said plurality of I-pictures is inserted every certain number of frames, in a Transport Stream (TS) which a user wants to transmit;
a location information synthesizing unit for synthesizing the searched location information into a predetermined area for the Transport Stream, thereby to generate a synthesized Transport Stream and
a transmitting unit for transmitting the synthesized Transport Stream including the location information.

16. The broadcasting signal transmitting apparatus according to claim 15, wherein said predetermined area is a null packet of the Transport Stream.

17. The broadcasting signal transmitting apparatus according to claim 15, wherein the location information searching unit forms a table of location values of the location information obtained from searched results in order to make the TS.
